(19) United States
(12) Patent Application Publication
(10) Pub. No.: US 2026/0134523 A1
(43) Pub. Date: May 14, 2026

(54) PAN-SHARPENING METHOD BASED ON MULTIMODAL TEXTURE CORRECTION AND ADAPTIVE EDGE DETAIL FUSION

(71) Applicant: Dalian Minzu University, Dalian City (CN)

(72) Inventors: Liguo WANG, Dalian City (CN); Danfeng LIU, Dalian City (CN); Enyuan WANG, Dalian City (CN); Haitao LIU, Dalian City (CN)

(21) Appl. No.: 19/333,686

(22) Filed: Sep. 19, 2025

(30) Foreign Application Priority Data
Nov. 8, 2024 (CN) 202411587725.5

(51) Int. Cl. G06T 5/73; G06T 5/50; G06T 5/60

(52) U.S. Cl. CPC G06T 5/73; G06T 5/50; G06T 5/60; G06T 2207/10036; G06T 2207/10041; G06T 2207/20016; G06T 2207/20084; G06T 2207/20221

(57) ABSTRACT

A pan-sharpening method based on multimodal texture correction and adaptive edge detail fusion is provided, including: fusing upsampled low-resolution multispectral (LRMS) images with panchromatic images to obtain fused images; respectively extracting intensity components of the LRMS image and the fused image; inputting the intensity components and the panchromatic images into a multimodal texture correction model, and performing optimization solution on the multimodal texture correction model through optimization method to obtain texture-corrected images; extracting details of the texture-corrected images and applying edge protection to obtain first image details; extracting details of the upsampled LRMS image and applying edge protection to obtain second image details; performing adaptive fusion on the first image details and the second image details to obtain detail information; and adding the detail information to the upsampled LRMS image to obtain final high-resolution multispectral (HRMS) images.

### CROSS-REFERENCE TO RELATED APPLICATIONS

This application claims priority to Chinese Patent Application No. 202411587725.5, filed on Nov. 8, 2024, the contents of which are hereby incorporated by reference.

### TECHNICAL FIELD

The disclosure belongs to the technical field of image fusion, and in particular to a pan-sharpening method based on multimodal texture correction and adaptive edge detail fusion.

### BACKGROUND

Due to the limitations of satellite imaging sensor hardware, it is impossible to obtain multispectral (MS) images with both high spatial resolution and high spectral resolution simultaneously. However, spectral sensors may be used to obtain MS images with rich spectral information but low spatial resolution, and spatial sensors may be used to obtain panchromatic (PAN) images with high spatial resolution but poor spectral information. Therefore, pan-sharpening technology is adopted to improve the spatial resolution of low-resolution multispectral (LRMS) images. By fusing LRMS and PAN images and utilizing their respective advantages, high-resolution multispectral (HRMS) images are finally obtained.

Pan-sharpening refers to the process of fusing MS images and panchromatic (PAN) images to obtain HRMS images. However, due to the low correlation and similarity between MS and PAN images, as well as the inaccurate injection of spatial information, the HRMS images suffer from serious spectral and spatial distortions.

With the rapid development of pan-sharpening technology, it may be divided into 4 categories: component substitution (CS)-based methods, multi-resolution analysis (MRA)-based methods, variational optimization (VO)-based methods, and deep learning (DL)-based methods. CS-based methods may usually retain spatial details well, achieving high spatial quality, and are easy to implement, and have high computational efficiency, but they are prone to serious spectral distortion. MRA-based methods may retain spectral information well, but the decomposition of spatial structures is likely to cause spatial distortion. VO-based methods may consider the problems of spectral and spatial distortion in images, apply spectral prior constraints and spatial prior constraints between MS, PAN and ideal HRMS images, perform correction of regularization prior constraints, construct a reasonable degradation model, and solve the model through optimization algorithms. VO-based methods usually retain spatial and spectral information better than CS and MRA-based methods, and obtain better fusion results. However, once unreasonable model assumptions are made, unpredictable deviations usually occur. Therefore, this type of method needs to establish more accurate mathematical models, and its efficiency also needs to be further improved. Generally speaking, DL-based methods may achieve good fusion results, but they require a large number of images to train the network, consume a lot of computing resources, and the test images are highly correlated with the training data, and the parameters of the network after training are fixed, which usually may not adapt to other new datasets from different sensors, and the accuracy of DL-based methods may not be further improved.

At present, the above pan-sharpening methods all have the problem of low correlation and similarity between MS and PAN images, resulting in inaccurate extraction of spatial details and other information, and even only extracting spatial details from PAN images. It is difficult to balance spectral and spatial information during the fusion process, leading to spatial and spectral distortions in the fused image, resulting in insufficiently good fusion effect of the final HRMS. Even though deep learning-based methods may be used to balance spectral and spatial information, for example, supervised training networks may only be applied to the current dataset during testing, and frequent training on different datasets will lead to a sharp increase in costs such as training time.

### SUMMARY

In order to solve the above technical problems, the disclosure proposes a pan-sharpening method based on multimodal texture correction and adaptive edge detail fusion to solve the problems existing in the prior art.

To achieve the above objective, the disclosure provides a pan-sharpening method based on multimodal texture correction and adaptive edge detail fusion, including:
obtaining a low-resolution multispectral (LRMS) image and a panchromatic image, fusing the upsampled LRMS image with the panchromatic image to obtain a fused image, respectively extracting intensity components of the LRMS image and the fused image, inputting the intensity components of the LRMS image, the intensity components of the fused image and the panchromatic image into a multimodal texture correction model, and performing optimization solution on the multimodal texture correction model through an optimization method to obtain a texture-corrected image, where the multimodal texture correction model is constructed based on a variational optimization model; and
performing detail extraction and edge protection on the texture-corrected image to obtain first image details; performing detail extraction and edge protection on the upsampled LRMS image to obtain second image details; performing adaptive fusion on the first image details and the second image details to obtain detail information, and adding the detail information to the upsampled LRMS image to obtain a final high-resolution multispectral (HRMS) image.

Optionally, the intensity components of the LRMS image and the fused image are extracted by performing linear weighted summation on each band image of the LRMS image and each band image of the fused image.

Optionally, the fused image is obtained by fusing the upsampled LRMS image with the panchromatic image through a target-adaptive convolutional neural networks (CNN)-based pansharpening (A-PNN) model based on a target adaptive convolutional neural network.

Optionally, the multimodal texture correction model is:

$${T}_{C} = {arg min}_{{T}_{C}} \frac{1}{2} {‖ {DHT}_{C} - {I}_{0} ‖}_{F}^{2} + \frac{α}{2} {‖ {∇}^{2} {T}_{C} - {∇}^{2} P ‖}_{F}^{2} + \frac{β}{2} {‖ {∇}^{2} ( {DHT}_{C} ) - {∇}^{2} {I}_{0} ‖}_{F}^{2} + \frac{γ}{2} {‖ {T}_{C} - {I}_{net} ‖}_{F}^{2} + \frac{δ}{2} {‖ {∇}^{2} {T}_{C} - {∇}^{2} {I}_{net} ‖}_{F}^{2} + θ {‖ {∇}^{2} {T}_{C} ‖}_{1}$$

Where T_{C} is the texture-corrected image, D represents a downsampling matrix, H represents a degradation filter, I₀ represents the intensity component of the LRMS image, α, β, γ, δ, θ represent penalty parameters corresponding to different terms, ∇² is a Laplacian operator, P represents the panchromatic image, Iₙₑₜ represents the intensity component of the fused image, ∥·∥_{F} represents the Frobenius norm, and ∥·∥₁ represents the 1-norm;

Optionally, the degradation filter H is obtained through an adaptive degradation filter algorithm, where the degradation filter H adopts a Gaussian filter H_{A}, and the adaptive degradation filter algorithm is:

$${H}_{A} = {arg min}_{{H}_{A}} \frac{1}{2} {‖ {DH}_{A} {T}_{C} - {I}_{0} ‖}_{F}^{2}$$

Where DH_{A}T_{C}=DF⁻¹(H_{A} (u, v) F(T_{C}));
the frequency domain expression H_{A} (u, v) of the Gaussian filter H_{A} is:

$${H}_{A} ( u , v ) = {e}^{- \frac{{D}_{C}^{2} ( u , v )}{2 {σ}^{2}}}$$

Where D_{C} (u, v) represents the distance from the point (u, v) to the center of the frequency domain, σ represents the standard deviation, σ obtains the optimal value according to correlation and similarity indexes, and the optimal value of σ is σ_{best}:

$${σ}_{b e s t} = {arg max}_{σ} \frac{ρ ( {DH}_{A} {T}_{C} , {I}_{0} ) + S ( D {H}_{A} {T}_{C} , {I}_{0} )}{2}$$

Where ρ (DH_{A}T_{C}, I₀) is the CC index between DH_{A}T_{C} and I₀, and S (DH_{A}T_{C}, I₀) is the SSIM index between DH_{A}T_{C} and I₀.

Optionally, the multimodal texture correction model is optimized and solved through an alternating direction method of multipliers (ADMM) model.

Optionally, the process of extracting details from the texture-corrected image includes:

$${D}_{{T}_{C}} = {T}_{C} - {T}_{C L}$$

Where D_{TC} is image details of the texture-corrected image, T_{CL} is low-resolution version of the texture-corrected image,

$${T}_{C L} = {χ}_{1} {I}_{U P} + ( 1 - {χ}_{1} ) {T}_{CD} s . t . 0 < {χ}_{1} < 1$$

Where χ₁ represents a weight coefficient, I_{UP} represents the intensity component of the upsampled LRMS image, and T_{CD} represents the image of the texture-corrected image processed by the Gaussian filter;

$${χ}_{1} = \sqrt{1 - {e}^{- {x}_{3}}} s . t . {x}_{3} = \frac{{x}_{1}}{{x}_{1} + {x}_{2}}$$

Where x₃ represents a normalized weight, x₁ represents influence coefficient of I_{UP}, x₂ represents the influence coefficient of T_{CD}, the value of x₁ is mean value of correlation and similarity between T_{C} and I_{UP}, and value of x₂ is mean value of correlation and similarity between T_{C} and T_{CD}.

Optionally, the process of adaptively fusing the first image details and the second image details includes:

enhancing the second image details to the same level as the first image details according to a scale factor ξ:

$${F}_{3}^{i} = {ξ}_{i} {F}_{2}^{i}$$

Where F₂ represents second image details, F₃ represents enhanced second image details, and superscript or subscript i represents the band label corresponding to the image;
fusing the enhanced second image details with the first image details to obtain detail information F:

$${F}_{i} = {χ}_{2} {F}_{1} + ( 1 - {χ}_{2} ) {F}_{3}^{i}$$

Where χ₂ is a weight coefficient, χ₂=\sqrt{1−e^{-x}^{₁}}, where x₁ represents the influence coefficient of IUP, and the value of the x1 is the mean value of the correlation and similarity between TC and IUP, and F1 represents details of first image.

Optionally, the process of adding the detail information to the upsampled LRMS image includes:

$${M}_{HR}^{i} = {M}_{UP}^{i} + {g}_{i} \frac{{M}_{UP}^{i}}{\frac{1}{B} {\sum }_{i = 1}^{B} {M}_{UP}^{i}} {F}_{i}$$

Where g represents scale factor of injected details, M_{UP} is the upsampled LRMS image, B represents total number of the bands, i represents the band label, the superscript or subscript i represents the band label corresponding to the image, F represents the detail information, and M_{HR} is the HRMS image.

Optionally, the scale factor g for injecting details is:

$${g}_{i} = \frac{{σ}^{2} ( {T}_{C} ) + cov ( {T}_{C} , {M}_{UP}^{i} )}{{σ}^{2} ( {T}_{C} )}$$

Where cov(·) is a covariance function, σ² is a variance function, T_{C} represents the texture-corrected image, M_{UP} is the upsampled LRMS image, and the superscript or subscript i represents the band label corresponding to the image.

Compared with the prior art, the disclosure has the following advantages and technical effects.

In order to enhance the correlation and similarity between source images, a multimodal texture correction model is proposed. This model takes the intensity component of the LRMS image, the PAN image and the intensity component of the image fused by A-PNN as the input end, and the output end is the texture-corrected image. The model applies intensity correction constraints between images, gradient correction constraints among the texture-corrected image, the intensity component of the LRMS image and the PAN image, and deep plug-and-play correction priors based on A-PNN between the texture-corrected image and the intensity component of the image fused by A-PNN.

Since the degradation filter is difficult to determine in the intensity correction constraint, an adaptive degradation filter algorithm is proposed to ensure the accuracy of the establishment of each constraint prior. The algorithm may adaptively determine the degradation filter in the model, thereby enhancing the correlation and similarity between the texture-corrected image and the source image in the multimodal texture correction model.

In order to realize the accuracy of spatial information injection, an adaptive edge detail fusion model is proposed. The model adaptively extracts the detail information of the texture-corrected image and applies edge protection, similarly extracts the detail information of the upsampled multispectral (MS) image and applies edge protection, and elevates the spatial information of the upsampled MS image to the same level as the texture-corrected image, and finally adaptively fuses the spatial information of the texture-corrected image and the upsampled MS image to obtain more accurate spatial information.

### BRIEF DESCRIPTION OF THE DRAWINGS

The accompanying drawings forming a part of the present application are used to provide a further understanding of the present application. The schematic embodiments and descriptions of the present application are used to explain the present application, and do not constitute an improper limitation of the present application. In the accompanying drawings:

FIG. 1 is a block diagram of the method flow of the embodiment of the disclosure.

FIG. 2 is a schematic diagram of the iterative convergence result of the WorldView-3 dataset according to the embodiment of the disclosure.

### DETAILED DESCRIPTION OF THE EMBODIMENTS

It should be noted that embodiments in the application and the features in the embodiments may be combined with each other if there is no conflict. The application will be described in detail below with reference to the accompanying drawings and in combination with the embodiments.

It should be noted that the steps shown in the flowcharts of the accompanying drawings may be executed in a computer system such as a set of computer executable instructions, and although a logical order is shown in the flowcharts, in some cases, the steps shown or described may be executed in an order different from that here.

In order to solve the problems pointed out in the above technical background, the disclosure proposes a pan-sharpening method based on multimodal texture correction and adaptive edge detail fusion. In order to obtain a texture-corrected image T_{C} highly correlated and similar to the multispectral (MS) image, a pan-sharpening (A-PNN) fusion method based on a target adaptive convolutional neural network is introduced. By constructing a multimodal texture correction model, intensity, gradient and deep plug-and-play correction constraints based on A-PNN are established between the texture-corrected image and the source image, and an adaptive degradation filter algorithm is proposed to ensure the accuracy of the establishment of these constraints. Since the obtained texture-corrected image may replace the panchromatic (PAN) image, and the MS image also contains part of spatial information, an adaptive edge detail fusion algorithm is proposed to adaptively extract the detail information of the texture-corrected image and the MS image respectively and apply edge protection. Since the MS image has less spatial information, its spatial information is enhanced in proportion and then adaptively fused. The fused spatial information is injected into the upsampled multispectral (UPMS) image to obtain the final HRMS image. A large number of experimental results show that compared with other methods, the algorithm proposed in the disclosure achieves better results in both subjective visual effects and objective evaluation indexes, and maintains high operation efficiency.

Related work and related technical basis involved in the disclosure are as follow:

### Injection Model:

the injection model is commonly used in pan-sharpening methods. It generates HRMS images by injecting high-spatial-resolution spatial detail information from PAN images into the original UPMS images with high spectral resolution, so as to solve the problem that LRMS images lack a large amount of spatial information. It is assumed that the size of the LRMS image is L×W×B (that is, length×width×number of bands), and the size of the PAN image is L′×W′, where L′=L/r, W′=W/r, and r represents the compression ratio. Then the sizes of the UPMS and HRMS images are L′×W′×B. The specific formula of the injection model may be uniformly expressed as:

$${M}_{H R} = {M}_{U P} + G {S}_{D} ; \qquad ( 1 )$$

where M_{HR} is the HRMS image, M_{UP} is the UPMS image, G is the injection gain, and S_{D} is the injected spatial detail information. Methods for extracting S_{D} may be uniformly divided into CS-based methods and MRA-based methods. For CS-based methods, S_{D} may be extracted using the following formula:

$${S}_{D} = {P}_{I} - {I}_{U P} ; \qquad ( 2 )$$

where P_{I} represents the image obtained by histogram matching between the PAN and the intensity component of the UPMS image (I_{UP}). Histogram matching ensures that the intensity and contrast of the PAN and LRMS images are within the same grayscale range, ensuring the accuracy of spatial information extraction. The formula of P_{I} is as follows:

$${P}_{I} = \frac{{σ}_{I}}{{σ}_{P}} ( P - {μ}_{P} ) + {μ}_{I} ; \qquad ( 3 )$$

where P represents the original PAN image, μ_{P} and μ_{I} represent the average values of P and I_{UP} images respectively, σ_{P} and σ_{I} represent the variances of P and I_{UP} images respectively. I_{UP} is obtained by linearly weighting each band of M_{UP}, and its formula is as follows:

$${I}_{UP} {\sum }_{i = 1}^{B} {ω}_{i} {M}_{UP}^{i} ; \qquad ( 4 )$$

where ω represents the linear weighting coefficient, the superscript or subscript i represents the i-th band of the image, and B represents the total number of bands. For MRA-based methods, S_{D} may be extracted using the following formula:

$$\begin{matrix}{S}_{D} = P - {P}_{D} \\ {P}_{D} = {H}_{L P} P\end{matrix} ; \qquad ( 5 )$$

where P_{D} represents the degraded PAN image, which may be obtained by using a low-pass filter H_{LP} on the PAN image P, and H_{LP} has a blurring effect on P.

However, problems such as inaccurate injected spatial detail information still exist. Since the missing spatial detail information in the LRMS image is generally inferred from the PAN image, inaccurate inference and possible mismatching of spectral information during the fusion process make it impossible to maintain accurate spectral fidelity and spatial fidelity at the same time, which in turn leads to spectral and spatial distortions in the fused image.

### Variational Optimization Model:

variational optimization methods have become popular in recent years, which may ensure that image spectral and spatial information as accurate as possible by establishing mathematical models. The established mathematical model may be regarded as a degradation model, in which the ideal HRMS image after fusion is recovered from the LRMS and PAN images, that is, the ideal HRMS image is an inverse process of degenerating into the source image. Therefore, variational optimization-based methods may retain the spatial and spectral information of LRMS and PAN images through various optimization algorithms, and finally restore the desired ideal HRMS image. To sum up, variational optimization methods generally establish an energy function among LRMS, PAN and the ideal HRMS image E(M_{HR}), and the methods may be divided into three terms: the first term is the spectral fidelity term f_{spectral} (M₀, M_{HR}), the second term is the spatial fidelity term fₛₚₐₜᵢₐₗ (P, M_{HR}), and the third term is the regularization prior term fₚᵣᵢₒᵣ (M_{HR}). The specific formula is as follows:

$$E ( {M}_{HR} ) = {f}_{spectral} ( {M}_{0} , {M}_{HR} ) + {f}_{spatial} ( P , {M}_{HR} ) + {f}_{p r i o r} ( {M}_{H R} ) ; \qquad ( 6 )$$

where M₀ is the LRMS image. M₀ may be obtained by blurring and downsampling the ideal HRMS image H_{MR}. M_{HR} may also be obtained by linearly weighted combination to get the PAN image P. Therefore, the energy function in formula (6) may be simplified to the following common form:

$$E ( {M}_{HR} ) = {λ}_{1} ‖ ( {DH}_{L P} {M}_{H R} - {M}_{0} ) ‖ + ‖ P - {CM}_{H R} ‖ + {λ}_{2} {f}_{p r i o r} ( {M}_{H R} ) ; \qquad ( 7 )$$

where λ₁ and λ₂ are penalty parameters, D represents a downsampling matrix, and C represents a linear weighted combination matrix. By optimizing and solving the above formula, M_{HR} may finally be obtained.

Although variational optimization methods may retain relatively accurate spectral and spatial information at the same time, they depend on the accuracy of mathematical model establishment. Unreasonable variational optimization models will ignore the correlation and similarity between MS and PAN images, and the obtained spectral and spatial information may not match, which will lead to spectral and spatial distortions in the final HRMS image. In addition, the efficiency of most variational optimization models is relatively low.

The specific related method flow involved in the disclosure is described as follow:
in order to solve the problems of poor correlation and similarity among LRMS, PAN and HRMS images, and inaccurate spatial information injected into UPMS images, a pan-sharpening method based on multimodal texture correction and adaptive edge detail fusion is proposed. This method may improve the spectral and spatial distortions of HRMS images.

The input end of the multimodal texture correction model is the intensity component I₀ of the LRMS image, the PAN image and the intensity component of the image fused by A-PNN, and the output end is the texture-corrected image T_{C}. Intensity constraints between I₀ and T_{C} images are corrected by establishing intensity correction priors. Gradient constraints among I₀, PAN and T_{C} images are corrected by establishing gradient correction priors. Intensity gradient constraints between Iₙₑₜ and T_{C} images are corrected by establishing deep plug-and-play correction priors based on A-PNN. These three correction priors form the basis of the multimodal texture correction model. In addition, an adaptive degradation filter algorithm is proposed, which may be used to obtain an accurate adaptive degradation filter H_{A} in the intensity correction prior to degrade T_{C}, so that the correlation and similarity between the degraded T_{C} and I₀ images are the highest. Finally, the multimodal texture correction model is optimized by alternating direction method of multipliers (ADMM) to obtain the texture-corrected image T_{C}. Due to the high correlation and similarity between the texture-corrected image T_{C} and the source images, the T_{C} maintains the spectral information of the LRMS image unchanged while inheriting gradient information from the PAN image, and the intensity component Iₙₑₜ of the image fused by A-PNN has more image features, which may further maintain the stability of texture information. Therefore, the texture-corrected image T_{C} may be used to replace the PAN image for subsequent fusion operations.

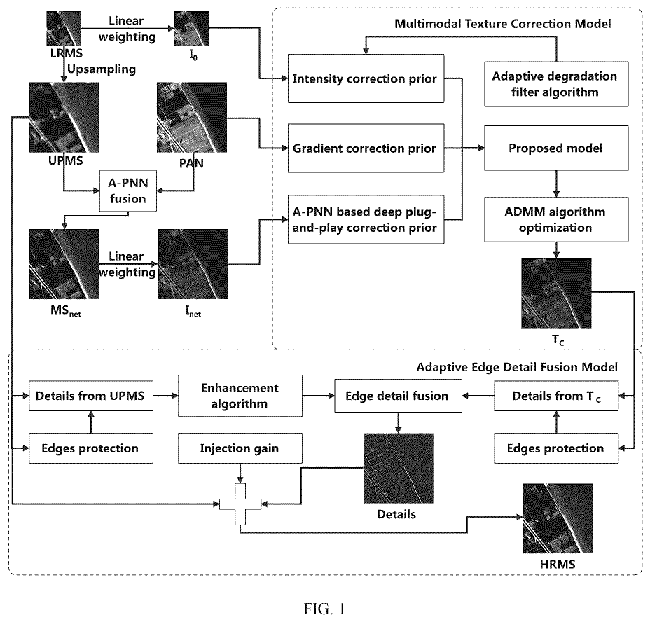

After obtaining the texture-corrected image T_{C}, the texture-corrected image T_{C} and the multispectral MS image are fused through an adaptive edge detail fusion model to generate the final HRMS image;
in the adaptive edge detail fusion model, since spatial detail information exists not only in the texture-corrected image T_{C} that replaces the PAN image, but also in the multispectral MS image. Therefore, the detail information of the texture-corrected image T_{C} is adaptively extracted and edge protection is applied, and the detail information in the UPMS image is extracted by using a Gaussian filter matching the modulation transfer function (MTF) and edge protection is applied. The detail information of the UPMS image with edge protection is enhanced to the same level as the texture-corrected image T_{C}, and adaptively fused with the detail information of the texture-corrected image T_{C} with edge protection to obtain spatial information with high correlation and similarity to the source image. The spatial information is injected into the UPMS image in an appropriate proportion to obtain the final HRMS image. The method flow block diagram of the disclosure is shown in FIG. 1. The specific process is shown in the following content.

Specifically, the multimodal texture correction model mainly includes an intensity correction prior term, a gradient correction prior term and a deep plug-and-play correction prior term based on A-PNN; where the relevant filters in the intensity correction prior term and the gradient correction prior term are determined by an adaptive degradation filter algorithm, and the multimodal texture correction model is optimized and solved by an optimization model algorithm to obtain the final texture-corrected image, and the specific content is as follows.

### Intensity Correction Prior Term:

based on the spectral fidelity term in the variational optimization model in the above technical basis, the LRMS image may be obtained by blurring and downsampling the HRMS image, and the specific formula is as follows:

$${f}_{spectral}^{i} = \frac{1}{2} {‖ {DHM}_{HR}^{i} - {M}_{0}^{i} ‖}_{F}^{2} ; \qquad ( 8 )$$

where H is generally a Gaussian smoothing filter, and ∥·∥_{F} represents the Frobenius norm. In order to keep the intrinsic correlation and similarity between bands unchanged, the LRMS and ideal HRMS images of each band are linearly weighted and summed by formula (4) to obtain I₀ and the intensity component I_{HR} of the ideal HRMS image, and the specific formula is as follows:

$${f}_{spectral 1} = \frac{1}{2} {‖ DH {\sum }_{i = 1}^{B} {ω}_{i} {M}_{HR}^{i} - {\sum }_{i = 1}^{B} {ω}_{i} {M}_{0}^{i} ‖}_{F}^{2} = \frac{1}{2} {‖ {DHI}_{HR} - {I}_{0} ‖}_{F}^{2} . \qquad ( 9 )$$

Since I_{HR} is unknown, it is assumed that T_{C} is close to I_{HR} and highly correlated. Therefore, the intensity correction prior term E_{intensity} is as follows:

$${E}_{i n t e n s i t y} = \frac{1}{2} {‖ DH {T}_{C} - {I}_{0} ‖}_{F}^{2} . \qquad ( 10 )$$

### Gradient Correction Prior Term:

in the intensity correction prior model, T_{C} maintains the invariance of spectral information, but spatial information is also required to be retained. Based on the spatial fidelity term in the variational optimization model in the above technical basis, the gradient information of the PAN image is retained by establishing a spatial fidelity term, and the specific formula is as follows:

$${f}_{spatial 1} = \frac{α}{2} {‖ {∇}^{2} {T}_{C} - {∇}^{2} P ‖}_{F}^{2} ; \qquad ( 11 )$$

where α is a penalty parameter and ∇² is a Laplacian operator. Since the correction of the gradient information of the PAN image by T_{C} may lead to deviations in the intensity correction between T_{C} and I₀ images, it is necessary to establish another spatial fidelity term to keep the intensity correction from deviating during the gradient correction process and further enhance the correlation and similarity between T_{C} and I₀ images, and the specific formula is as follows:

$${f}_{spatial 2} = \frac{β}{2} {‖ {∇}^{2} ( D H {T}_{C} ) - {∇}^{2} {I}_{0} ‖}_{F}^{2} ; \qquad ( 12 )$$

where β is a penalty parameter. To sum up, the gradient correction prior term may be expressed as follows:

$${E}_{gradient} = \frac{α}{2} {‖ {∇}^{2} {T}_{C} - {∇}^{2} P ‖}_{F}^{2} + \frac{β}{2} {‖ {∇}^{2} ( {DHT}_{C} ) - {∇}^{2} {I}_{0} ‖}_{F}^{2} . \qquad ( 13 )$$

### Deep Plug-and-Play Correction Prior Term Based on A-PNN:

in order to generate more texture features, further improve the correlation and similarity between T_{C} and I₀, PAN images, and retain more spectral and spatial information, the PAN and UPMS images are fused by A-PNN to obtain an HRMS image, denoted as MSₙₑₜ. The intensity component Iₙₑₜ of MSₙₑₜ is obtained by linearly weighting MSₙₑₜ through formula (4). A-PNN is a technology well known to those skilled in the art, which is a pan-sharpening method based on a target adaptive convolutional neural network. Based on the spectral fidelity term in the variational optimization model in the above technical basis, the intensity information of T_{C} is corrected by establishing a spectral fidelity term between T_{C} and Iₙₑₜ, and the specific formula is as follows:

$${f}_{spectral 2} = \frac{γ}{2} {‖ {T}_{C} - {I}_{n e t} ‖}_{F}^{2} ; \qquad ( 14 )$$

where γ is a penalty parameter. The gradient information of T_{C} is corrected by establishing a spatial fidelity term between T_{C} and Iₙₑₜ, and the specific formula is as follows:

$${f}_{spatial 3} = \frac{δ}{2} {‖ {∇}^{2} {T}_{C} - {∇}^{2} {I}_{net} ‖}_{F}^{2} ; \qquad ( 15 )$$

where δ is a penalty parameter. To sum up, the deep plug-and-play correction prior based on A-PNN may be expressed as follows:

$${E}_{DPP} = \frac{γ}{2} {‖ {T}_{C} - {I}_{net} ‖}_{F}^{2} + \frac{δ}{2} {‖ {∇}^{2} {T}_{C} - {∇}^{2} {I}_{net} ‖}_{F}^{2} . \qquad ( 16 )$$

### Multimodal Texture Correction Model:

in order to ensure the sparsity of the output texture map and reduce artifacts, in addition to combining the above intensity correction prior term, gradient correction prior term and deep plug-and-play correction prior term based on A-PNN, a total variation regularization term (TV) is also used, where

$$TV = θ {‖ {∇}^{2} {T}_{C} ‖}_{1} .$$

For this reason, the disclosure proposes a multimodal texture correction model, and the specific formula is as follows:

$${T}_{C} = {arg min}_{{T}_{C}} \frac{1}{2} {‖ {DHT}_{C} - {I}_{0} ‖}_{F}^{2} + \frac{α}{2} {‖ {∇}^{2} {T}_{C} - {∇}^{2} P ‖}_{F}^{2} + \frac{β}{2} {‖ {∇}^{2} ( {DHT}_{C} ) - {∇}^{2} {I}_{0} ‖}_{F}^{2} + \frac{γ}{2} {‖ {T}_{C} - {I}_{net} ‖}_{F}^{2} + \frac{δ}{2} {‖ {∇}^{2} {T}_{C} - {∇}^{2} {I}_{net} ‖}_{F}^{2} + θ {‖ {∇}^{2} {T}_{C} ‖}_{1} ; \qquad ( 17 )$$

where θ is a penalty parameter.

### Adaptive Degradation Filter Algorithm:

in the model shown in formula (17), all are determined except the Gaussian filter H and the texture-corrected image T_{C}. The texture-corrected image T_{C} may be determined by algorithm 2, while H is difficult to determine. Therefore, the disclosure proposes an adaptive degradation filter algorithm, which uses a Gaussian filter as the degradation filter, defined as H_{A}, and may be determined by the following formula:

$${H}_{A} = {arg min}_{{H}_{A}} \frac{1}{2} {‖ {DH}_{A} {T}_{C} - {I}_{0} ‖}_{F}^{2} . \qquad ( 18 )$$

It may be known from the above formula that when the difference between the texture-corrected image DH_{A}T_{C} processed by downsampling and the degradation filter and the intensity component I₀ of the LRMS image is the smallest, that is, when the correlation and similarity between the two reach the highest, H_{A} at this time is the best degradation filter. Therefore, the adaptive degradation filter algorithm comprehensively considers the correlation and similarity between the two, which are measured by the correlation coefficient (CC) and structural similarity index measure (SSIM) respectively, and finally adaptively determines the best degradation filter. When the filter is processed in the spatial domain of the image, the convolution operation will greatly increase the computational complexity. When processing in the image frequency domain, the convolution operation is converted into an inner product operation, which will greatly reduce the computational complexity. Therefore, H_{A} is selected to be calculated in the frequency domain, and the frequency domain expression of H_{A} is:

$${H}_{A} ( u , v ) = {e}^{- \frac{{D}_{C}^{2} ( u , v )}{2 {σ}^{2}}} ; \qquad ( 19 )$$

where D_{C} (u, v) represents the distance from the point (u, v) to the center of the frequency domain, and σ represents the standard deviation. After H_{A} is converted to the frequency domain, T_{C} also needs to be calculated in the frequency domain. Therefore, the fast Fourier transform (FFT) is used to convert T_{C} into the frequency domain, and the inverse fast Fourier transform (IFFT) is used to convert H_{A}T_{C} back to the spatial domain, which is convenient for the subsequent correlation and similarity operations between DH_{A}T_{C} and I₀. The specific formula is as follows:

$${DH}_{A} {T}_{C} = {DF}^{- 1} ( {H}_{A} ( u , v ) F ( {T}_{C} ) ) ; \qquad ( 20 )$$

where F(·) represents the FFT operation, and F⁻¹(·) represents the IFFT operation. To sum up, the key to determining H_{A} is to determine the unknown parameter σ. Therefore, the best σ may be found by correcting the correlation and similarity between DH_{A}T_{C} and I₀. The correlation is measured by the CC index, denoted as ρ (DH_{A}T_{C}, I₀) and the similarity is measured by the SSIM index, denoted as S (DH_{A}T_{C}, I₀). The average rule is used to comprehensively consider these two indexes, and iterative processing is performed with different σ values, and the maximum value is taken from the final results. At this time, σ is the best value, denoted as σ_{best}.

The specific formula is as follows:

$${σ}_{best} = {arg max}_{σ} \frac{ρ ( {DH}_{A} {T}_{C} , {I}_{0} ) + S ( {DH}_{A} {T}_{C} , {I}_{0} )}{2} . \qquad ( 21 )$$

To sum up, the overall process of the adaptive degradation filter algorithm is shown in Algorithm 1.

### Algorithm 1:

### Algorithm 1: Adaptive Degradation Filter Algorithm

Input: texture-corrected image T_{C}, intensity component I₀ of the LRMS image,
initializing: setting σ⁽⁰⁾=1, step size s=0.5, iteration step k=0,
converting H_{A} to the frequency domain by formula (19),
calculating (DH_{A}T_{C}, I₀) by formula (20),
calculating ρ⁽⁰⁾ (DH_{A}T_{C}, I₀) and S⁽⁰⁾ (DH_{A}T_{C}, I₀).
Circulating: σ^{(k+1)}=σ^{(k)}+s, k=k+1,
optimizing (DH_{A}T_{C})^{(K+1)} by formula (20),
optimizing ρ^{(k+1)} (DH_{A}T_{C}, I₀) and S (k+1) (DH_{A}T_{C}, I₀),
calculating

$${σ}^{( k + 1 )} = \frac{{ρ}^{( k + 1 )} ( {DH}_{A} {T}_{C} , {I}_{0} ) + {S}^{( k + 1 )} ( {DH}_{A} {T}_{C} , {I}_{0} )}{2} , \qquad by formula ( 21 )$$

until σ^{(k+1)}<σ^{(k)} is satisfied, break the loop.
Output: σ_{best}=σ^{(k)}, adaptive degradation filter H_{A}.

### Optimization Model Algorithm:

the optimization model algorithm uses ADMM for optimization, which is an optimization method that decomposes the original problem into multiple easy-to-handle subproblems. To facilitate the optimization process, different auxiliary variables A=H_{A}T_{C}, C=∇²T, namely B=DA, is introduced, then the model of formula (17) may be expressed as:

$${min}_{A , B , C} \frac{1}{2} {‖ B - {I}_{0} ‖}_{F}^{2} + \frac{α}{2} {‖ {∇}^{2} {T}_{C} - {∇}^{2} P ‖}_{F}^{2} + \frac{β}{2} {‖ {∇}^{2} B - {∇}^{2} {I}_{0} ‖}_{F}^{2} + \frac{γ}{2} {‖ {T}_{C} - {I}_{net} ‖}_{F}^{2} + \frac{δ}{2} {‖ {∇}^{2} {T}_{C} - {∇}^{2} {I}_{net} ‖}_{F}^{2} + θ {‖ C ‖}_{1} s . t . A = {H}_{A} {T}_{C} , B + DA , C = {∇}^{2} {T}_{C} . \qquad ( 22 )$$

The augmented Lagrangian function of the above formula may be expressed as:

$${E}_{L} ( A , B , {T}_{C} , {H}_{A} , C , {Λ}_{1} , {Λ}_{2} , {Λ}_{3} ) = \frac{1}{2} {‖ B - {I}_{0} ‖}_{F}^{2} + \frac{α}{2} {‖ {∇}^{2} {T}_{C} - {∇}^{2} P ‖}_{F}^{2} + \frac{β}{2} {‖ {∇}^{2} B - {∇}^{2} {I}_{0} ‖}_{F}^{2} + \frac{γ}{2} {‖ {T}_{C} - {I}_{net} ‖}_{F}^{2} + \frac{δ}{2} {‖ {∇}^{2} {T}_{C} - {∇}^{2} {I}_{net} ‖}_{F}^{2} + θ {‖ C ‖}_{1} + {Λ}_{1}^{T} ( A - {H}_{A} {T}_{C} ) + {Λ}_{2}^{T} ( B - DA ) + {Λ}_{3}^{T} ( C - {∇}^{2} {T}_{C} ) + \frac{{μ}_{1}}{2} {‖ A - {H}_{A} {T}_{C} ‖}_{F}^{2} + \frac{{μ}_{2}}{2} {‖ B - DA ‖}_{F}^{2} + \frac{{μ}_{3}}{2} {‖ C - {∇}^{2} {T}_{C} ‖}_{F}^{2} ; \qquad ( 23 )$$

where Λ₁, Λ₂, Λ₃ are different Lagrange multipliers, and μ₁, μ₂, μ₃ are different penalty parameters. To minimize the energy function of the above formula, A^{(k+1)}, B^{(k+1)}, TC^{(k+1)}, HA^{(k+1)}, C^{(k+1)}, Λ₁^{(k+1)}, Λ₂^{(k+1)} and Λ₃^{(k+1)} are optimized iteratively to finally obtain T_{C}, where k is the number of iterations, and different parameters with the superscript k+1 represent the corresponding parameters in the (k+1)-th iteration process. The specific optimization process is as follows.

### (1) Optimizing A^{(k+1)}

Fixing other variables, the subproblem of A (k+1) is as follows:

$${A}^{( k + 1 )} = {arg min}_{A} {( {Λ}_{1}^{( k )} )}^{T} ( {A}^{( k )} - {H}_{A}^{( k )} {T}_{C}^{( k )} ) + {( {Λ}_{2}^{( k )} )}^{T} ( {B}^{( k )} - {DA}^{( k )} ) + \frac{{μ}_{1}}{2} {‖ {A}^{( k )} - {H}_{A}^{( k )} {T}_{C}^{( k )} ‖}_{F}^{2} + \frac{{μ}_{2}}{2} {‖ {B}^{( k )} - {DA}^{( k )} ‖}_{F}^{2} . \qquad ( 24 )$$

Setting the derivative of A^{(k+1)} to 0, that is, ∂E_{L}/∂A^{(k+1)}=0, then A^{(k+1)} is obtained by the following formula:

$${A}^{( k + 1 )} = \frac{- {Λ}_{1}^{( k )} + {D}^{T} {Λ}_{2}^{( k )} + {μ}_{1} {H}_{A}^{( k )} {T}_{C}^{( k )} + {μ}_{2} {D}^{T} {B}^{( k )}}{{μ}_{1} U + {μ}_{2} {D}^{T} D} ; \qquad ( 25 )$$

where U represents the identity matrix, and the superscript T represents the transpose operator.

### (2) Optimizing B^{(k+1)}

Fixing other variables, the subproblem of B^{(k+1)} is as follows:

$${B}^{( k + 1 )} = {arg min}_{B} \frac{1}{2} {‖ {B}^{( k )} - {I}_{0} ‖}_{F}^{2} + \frac{β}{2} {‖ {∇}^{2} {B}^{( k )} - {∇}^{2} {I}_{0} ‖}_{F}^{2} + {( {Λ}_{2}^{( k )} )}^{T} ( {B}^{( k )} - {DA}^{( k + 1 )} ) + \frac{{μ}_{2}}{2} {‖ {B}^{( k )} - {DA}^{( k + 1 )} ‖}_{F}^{2} . \qquad ( 26 )$$

Setting the derivative of B^{(k+1)} to 0, that is, ∂E_{L}/∂B^{(k+1)}=0. However, due to the existence of the Laplacian operator, the computational complexity increases in the solution process. To improve computational efficiency, FFT and IFFT are used for fast calculation in the frequency domain, and then converted back to the spatial domain. Therefore, after A^{(k+1)} is optimized, B^{(k+1)} may be obtained by the following formula:

$${B}^{( k + 1 )} = {F}^{- 1} ( \frac{F ( {I}_{0} + {β ( {∇}^{2} )}^{T} {∇}^{2} {I}_{0} - {Λ}_{2}^{( k )} + {μ}_{2} {DA}^{( k + 1 )} )}{F ( ( 1 + {μ}_{2} ) U + {β ( {∇}^{2} )}^{T} {∇}^{2} )} ) . \qquad ( 27 )$$

(3) Optimizing T_{C}^{(k+1)}

Fixing other variables, the subproblem of T_{C}^{(k+1)} is as follows:

$${T}_{C}^{( k + 1 )} = {arg min}_{{T}_{C}} \frac{α}{2} {‖ {∇}^{2} {T}_{C}^{( k )} - {∇}^{2} P ‖}_{F}^{2} + \frac{γ}{2} {‖ {T}_{C}^{( k )} - {I}_{net} ‖}_{F}^{2} + \frac{δ}{2} {‖ {∇}^{2} {T}_{C}^{( k )} - {∇}^{2} {I}_{net} ‖}_{F}^{2} + {( {Λ}_{1}^{( k )} )}^{T} ( {A}^{( k + 1 )} - {H}_{A}^{( k )} {T}_{C}^{( k )} ) + {( {Λ}_{2}^{( k )} )}^{T} ( {C}^{( k )} - {∇}^{2} {T}_{C}^{( k )} ) + \frac{{μ}_{1}}{2} {‖ {A}^{( k + 1 )} - {H}_{A}^{( k )} {T}_{C}^{( k )} ‖}_{F}^{2} + \frac{{μ}_{3}}{2} {‖ {C}^{( k )} - {∇}^{2} {T}_{C}^{( k )} ‖}_{F}^{2} . \qquad ( 28 )$$

Setting the derivative of T_{C}^{(k+1)} to 0, that is,

$$\partial {E}_{L} / \partial {T}_{C}^{( k + 1 )} = 0.$$

Due to the existence of the Laplacian operator, FFT and IFFT are also used for solution. Therefore, after A^{(k+1)} is optimized, T_{C}^{(k+1)} may be obtained by the following formula:

$${T}_{C}^{( k + 1 )} = {F}^{- 1} ( \frac{F ( a )}{F ( b )} ) \qquad ( 29 )$$

$$a = {α ( {∇}^{2} )}^{r} {∇}^{2} P + γ {I}_{net} + {δ ( {∇}^{2} )}^{r} {∇}^{2} {I}_{net} + {( {H}_{A}^{( k )} )}^{T} {Λ}_{1}^{( k )} + {( {∇}^{2} )}^{T} {Λ}_{3}^{( k )} + {{μ}_{1} ( {H}_{A}^{( k )} )}^{T} {A}^{( k + 1 )} + {{μ}_{3} ( {∇}^{2} )}^{T} {C}^{( k )}$$

$$b = ( α + δ + {μ}_{3} ) {( {∇}^{2} )}^{T} {∇}^{2} + γ + {{μ}_{1} ( {H}_{A}^{( k )} )}^{T} {H}_{A}^{( k )} .$$

### (4) Optimizing C^{(k+1)}

Fixing other variables, the subproblem of C^{(k+1)} is as follows:

$$\begin{matrix}{C}^{( k + 1 )} = {arg min}_{C} θ {‖ {C}^{( k )} ‖}_{1} + {( {Λ}_{3}^{( k )} )}^{T} ( {C}^{( k )} - {∇}^{2} {T}_{C}^{( k + 1 )} ) + \frac{{μ}_{3}}{2} {‖ {C}^{( k )} - {∇}^{2} {T}_{C}^{( k + 1 )} ‖}_{F}^{2} \\ = {arg min}_{C} \frac{θ}{{μ}_{3}} {‖ {C}^{( k )} ‖}_{1} + \frac{1}{2} {‖ {C}^{( k )} - ( {∇}^{2} {T}_{C}^{( k + 1 )} - \frac{{Λ}_{3}^{( k )}}{{μ}_{3}} ) ‖}_{F}^{2}\end{matrix} . \qquad ( 30 )$$

It is further simplified by using the SoftThresholding formula to obtain the following formula:

$$\begin{matrix}{C}^{( k + 1 )} = {S}_{T} ( {∇}^{2} {T}_{C}^{( k + 1 )} - \frac{{Λ}_{3}^{( k )}}{{μ}_{3}} , \frac{θ}{{μ}_{3}} ) \\ = sgn ( {∇}^{2} {T}_{C}^{( k + 1 )} - \frac{{Λ}_{3}^{( k )}}{{μ}_{3}} ) max ( \vert {∇}^{2} {T}_{C}^{( k + 1 )} - \frac{{Λ}_{3}^{( k )}}{{μ}_{3}} \vert - \frac{θ}{{μ}_{3}} , 0 )\end{matrix} ; \qquad ( 31 )$$

where sgn(·) is the sign function, and max(·) is the maximum function.
   (5) Optimizing Lagrange multipliers Λ₁^{(k+1)}, Λ₂^{(k+1)} and Λ₃^{(k+1)}

Fixing other variables, the subproblem of Λ₁^{(k+1)}, Λ₂^{(k+1)} and Λ₃^{(k+1)} are as follows:

$$\{ \begin{matrix}{Λ}_{1}^{( k + 1 )} = {Λ}_{1}^{( k )} + {φ}^{( k + 1 )} ( {A}^{( k + 1 )} - {H}_{A}^{( k + 1 )} {T}_{C}^{( k + 1 )} ) \\ {Λ}_{2}^{( k + 1 )} = {Λ}_{2}^{( k )} + {φ}^{( k + 1 )} ( {B}^{( k + 1 )} - D {A}^{( k + 1 )} ) \\ {Λ}_{3}^{( k + 1 )} = {Λ}_{3}^{( k )} + {φ}^{( k + 1 )} ( {C}^{( k + 1 )} - {∇}^{2} {T}_{C}^{( k + 1 )} )\end{matrix} ; \qquad ( 32 )$$

where φ is the step size required for gradient ascent, and the formula is as follows:

$${φ}^{( k + 1 )} = {τφ}^{( k )} ; \qquad ( 33 )$$

where τ is a penalty parameter, and generally τ>1 may accelerate the convergence speed. To sum up, the overall optimization process of the multimodal texture correction model is shown in Algorithm 2. where, in the iterative process, H_{A}^{(T+1)} is optimized by Algorithm 1, and when the relative change (RelCha) of T_{C} in two consecutive iterations is less than the tolerance deviation ε, the iterative process is exited, and the T_{C} image is finally obtained. The relative change discrimination formula is as follows:

$$RelCha = \frac{{‖ {T}_{C}^{( k + 1 )} - {T}_{C}^{( k )} ‖}_{F}}{{‖ {T}_{C}^{( k )} ‖}_{F}} < ε . \qquad ( 34 )$$

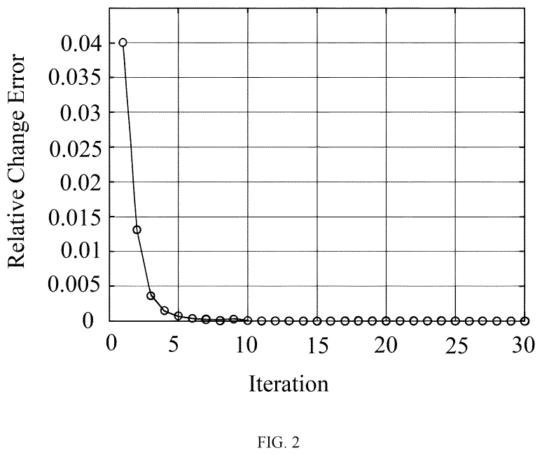

With the iteration, the relative change value RelCha gradually becomes smaller. Therefore, it is necessary to determine the parameter ε, which is slightly larger than RelCha, to balance the efficiency and accuracy of the model. For example, FIG. 2 shows the iterative convergence result of the test image in the WorldView-3 dataset. When the number of iterations reaches about 15, RelCha tends to converge and is close to 1×10⁻⁴, that is, ε may be assigned as 1×10⁻⁴.

### Algorithm 2:

### Algorithm 2: Optimization Algorithm of Multimodal Texture Correction Model

Input: panchromatic image P, intensity component I₀ of the LRMS image,
initializing: k=0, T_{C}⁽⁰⁾=P, H_{A}⁽⁰⁾, Λ₁⁽⁰⁾=Λ₂⁽⁰⁾=Λ₃⁽⁰⁾=U, φ⁽⁰⁾=1 and τ=10.1 are obtained by the initialization of Algorithm 1.
While RelCha>εdo

### Circulating:

optimizing A^{(k+1)} by the formula (25),
optimizing B^{(k+1)} by the formula (27),
optimizing T_{C}^{(k+1)} by the formula (29),
optimizing H_{A}^{(k+1)} by the Algorithm 1,
optimizing C^{(k+1)} by the formula (31),
optimizing Λ₁^{(k+1)}, Λ₂^{(k+1)} and Λ₃^{(k+1)} by the formula (32),

$${φ}^{( k + 1 )} = {τφ}^{( k )} , k = k + 1 .$$

Until RelCha≤ε is satisfied, break the loop.
Output: texture-corrected image T_{C}.

### Adaptive Edge Detail Fusion Model:

adaptively extract T_{C} image details and apply edge protection:
after obtaining T_{C} by Algorithm 2, the following formula is used to extract image details D_{TC}.

$${D}_{{T}_{C}} = {T}_{C} - {T}_{CL} ; \qquad ( 35 )$$

where T_{CL} is the low-resolution version of the T_{C} image. To extract details from T_{C} more accurately, it may be known from formulas (2) and (5) that T_{CL} may be obtained by two methods. The first method is to obtain the degraded image T_{CD} of T_{C} by applying Algorithm 1, which is similar to extracting details by MRA-based methods and better retains spectral information. The second method is to obtain I_{UP} by formula (4), which is similar to extracting details by CS-based methods and better retains spatial information. Therefore, considering the advantages of these two methods comprehensively, D_{TC} is adaptively extracted, and its algorithm design is as follows:

$$\begin{matrix}{T}_{CL} = {χ}_{1} {I}_{UP} + ( 1 - {χ}_{1} ) {T}_{CD} & s . t . 0 < {χ}_{1} < 1 ;\end{matrix} \qquad ( 36 )$$

where χ₁ represents the weight coefficient to be determined. Since the accuracy of detail extraction by the two methods is affected by the correlation and similarity between source images, the influence coefficient of I_{UP} may be set as χ₁, and the influence coefficient of T_{CD} may be set as X2, and their formulas are as follows:

$${x}_{1} = \frac{ρ ( {T}_{C} , {I}_{UP} ) + S ( {T}_{C} , {I}_{UP} )}{2} \qquad ( 37 )$$

$${x}_{2} = \frac{ρ ( {T}_{C} , {T}_{CD} ) + S ( {T}_{C} , {T}_{CD} )}{2} .$$

Since x₁ and x₂ do not satisfy the normalization constraint of χ₁, χ₁ is required to be positively correlated with x₁ and x₂ and within a reasonable range, so χ₁ may be obtained by the following formula:

$$\begin{matrix}{χ}_{1} = \sqrt{1 - {e}^{- {x}_{3}}} & s . t . {x}_{3} = \frac{{x}_{1}}{{x}_{1} + {x}_{2}}\end{matrix} . \qquad ( 38 )$$

Substitute χ₁ in the above formula into formula (36) to obtain T_{CL}, and then substitute it into formula (35) to finally obtain D_{TC}, completing the operation of adaptively extracting T_{C} image details. To retain edge information during detail extraction, the following edge detection matrix formula E_{TC} is used to extract edges:

$${E}_{{T}_{C}} = {e}^{- \frac{η}{{\vert ∇ T \vert}^{4} + ζ}} ; \qquad ( 39 )$$

where ∇ is the gradient operator, and η and ζ are modulation coefficients. Generally, let η=1×10⁻⁹, ζ=1×10⁻¹⁰. Therefore, the T_{C} image detail information with edge protection, that is, the first image detail F₁, is as follows:

$${F}_{1} = {D}_{{T}_{C}} {E}_{{T}_{C}} . \qquad ( 40 )$$

### Extracting UPMS Image Details and Applying Edge Protection:

the following formula is used to extract the detail information D_{M} of the UPMS image.

$${D}_{M}^{i} = {M}_{UP}^{i} - {M}_{UPL}^{i} ; \qquad ( 41 )$$

where M_{UPL} represents the low-resolution version of the UPMS image. Since M_{UPL} is unknown, the MTF obtained from the MS sensor is introduced as an important index for extracting details of the UPMS image. Therefore, a Gaussian filter H_{MG} matched with MTF is used to degrade the UPMS image to obtain the low-resolution version of the UPMS image, and the specific process is as follows:

$${M}_{UPL}^{i} = {H}_{MG} {M}_{UP}^{i} ; \qquad ( 42 )$$

The above formula into formula (41) is substituted to obtain the detail information of the UPMS image. At this time, it is necessary to use the edge detection matrix formula E_{M} to perform edge protection on D_{M}:

$${E}_{M}^{i} = {e}^{- \frac{η}{{\vert ∇ {M}_{UP}^{b} \vert}^{4} + ζ}} . \qquad ( 43 )$$

Therefore, the detail information of the UPMS image with edge protection, that is, the second image detail F₂, is as follows:

$${F}_{2}^{i} = {D}_{M}^{i} {E}_{M}^{i} . \qquad ( 44 )$$

### Adaptive Edge Detail Fusion Process:

after extracting the detail information with edge protection from T_{C} and UPMS images respectively, F₁ and F₂ may be fused. However, since the spatial resolution of the UPMS image is lower than that of T_{C}, F₂ contains less detail information than F₁, and directly fusing them may lose detail information. To avoid this, the information of F₂ is enhanced to the same level as F₁ before fusion. The specific formula is as follows:

$${ξ}_{i} = {arg min}_{{ξ}_{i}} \frac{1}{2} {‖ {F}_{1} - {ξ}_{i} {F}_{2}^{i} ‖}_{F}^{2} ; \qquad ( 45 )$$

where ξ is the scale factor. The linear regression model method is used to solve ξ. Therefore, the spatial information F₃ enhanced by ξ is expressed as:

$${F}_{3}^{i} = {ξ}_{i} {F}_{2}^{i} . \qquad ( 46 )$$

At this time, F₁ and F₃ may be adaptively fused to obtain detail information F, and the specific algorithm is as follows:

$${F}_{i} = {χ}_{2} {F}_{1} + ( 1 - {χ}_{2} ) {F}_{3}^{i} ; \qquad ( 47 )$$

where χ₂ is a weight coefficient. The weight distribution of detail information is affected by the correlation and similarity between the source images, that is, T_{C} and UPMS. Therefore, formula (37) may be used to set the relationship x₁ between T_{C} and I_{UP}, and at the same time, ensure that χ₂ is within a reasonable range, and x₁ is positively correlated with χ₂. The specific formula is as follows:

$${χ}_{2} = \sqrt{1 - {e}^{- {x}_{1}}} . \qquad ( 48 )$$

χ₂ in the above formula into formula (47) is substituted to obtain the final detail information.

### Final Injection of Spatial Edge Detail Information:

the detail information F in formula (47) is substituted into the following injection model to obtain the final HRMS image:

$${M}_{HR}^{i} = {M}_{UP}^{i} + {g}_{i} \frac{{M}_{UP}^{i}}{\frac{1}{B} {\sum }_{i = 1}^{B} {M}_{UP}^{i}} {F}_{i} ; \qquad ( 49 )$$

where g represents the scale factor of injected details, which may be adaptively determined by the following formula:

$${g}_{i} = \frac{{σ}^{2} ( {T}_{C} ) + cov ( {T}_{C} , {M}_{UP}^{i} )}{{σ}^{2} ( {T}_{C} )} ; \qquad ( 50 )$$

where cov(·) is a covariance function, and σ² is a variance function.

### Experimental Design and Conclusion for the Above Technical Scheme:

to illustrate the performance advantages and effectiveness of the method proposed in the disclosure, the method (Proposed) is compared with 8 methods including GSA, NIHS, BDSD-PC, SFIM, ATWT-W3, DMPIF, CDIF and A-PNN, and a large number of experiments are carried out using 3 datasets including QuickBird, WorldView-2 and WorldView-3. Each pair of images in each dataset includes one MS image and one PAN image. Among them, in the QuickBird dataset, the number of bands of the MS image is 4; while in the WorldView-2 and WorldView-3 datasets, the number of bands of the MS image is 8. All PAN images in the datasets contain only 1 band.

According to the Wald protocol, the original MS image is used as the reference image, that is, the ground truth (GT) image in this experiment. At this time, it is necessary to perform 4× downsampling degradation on the original MS and PAN images respectively. The degraded images may be used as the downscaled source images. The algorithm proposed in the disclosure is used to fuse the source images, and the fused image is compared with the GT image. The smaller the gap, the better the effect. Therefore, in this experiment, the size of each band of the GT image is cropped to 256*256, then the size of each band of the MS image is cropped to 6464, and the size of the PAN image is cropped to 256*256.

The specific information of these 3 datasets is summarized in this experiment, as shown in Table 1, which is the detailed information of the datasets used in this experiment.

TABLE 1

| | | | | Resolution |
|---|---|---|---|---|
| Satellite | MS bands | Sensor | Size | (m) |
| QuickBird | Blue (B), Green (G), Red | MS | 64 × 64 × 4 | 2.4 |
| | (R) and Near-infrared (NIR) | PAN | 256 × 256 | 0.61 |
| WorldView- | Coastal blue, B, G, R, Red | MS | 64 × 64 × 8 | 2 |
| 2 | edge, NIR 1 and NIR 2 | PAN | 256 × 256 | 0.5 |
| WorldView- | | MS | 64 × 64 × 8 | 1.24 |
| 3 | | PAN | 256 × 256 | 0.31 |

To evaluate and compare the image quality of different methods, a combination of subjective and objective evaluation criteria is adopted. 6 commonly used objective evaluation indexes are used for objective evaluation. Among them, the Q2n index (Q4 for 4-band datasets and Q8 for 8-band datasets) is selected to evaluate the spatial and spectral quality of images, the peak signal-to-noise ratio (PSNR) is used to measure the error degree between the reconstructed image and the reference image, the universal image quality index (UIQI) is used to more comprehensively evaluate the quality difference and similarity between the fused image and the reference image, the relative average spectral error (RASE) is used to evaluate the average spectral difference before and after image fusion, the overall dimensionless relative global error (ERGAS) is used to represent the distortion degree of image spatial and spectral information, and the spectral correlation coefficient (SCC) is used to measure the ability to retain image spectral information. For subjective evaluation, the fused MS images are visualized, and three bands of red (R), green (G) and blue (B) are extracted to display true-color fused images, which may more intuitively reflect the quality difference of images. Among the above evaluation indexes, the ideal values of Q2n, UIQI and SCC are 1, and the ideal value of PSNR is +∞, while RASE and ERGAS are ideally 0. All experiments in this section are run on a PC with an Inter Core i7-12700 CPU, a base speed of 2.10 GHz and a memory of 32 GB, and the experimental platform is MATLAB R2021b.

### Comparative Experiments

### QuickBird Dataset:

in the subjective evaluation of the QuickBird dataset, the subjective evaluation fusion results of the method proposed in the disclosure and various comparison methods are given, with the GT image as the reference image. After enlarging the local fusion results, it is able to be seen from the local enlargement that the GSA method shows too much detail information on the roof of the house. The images of BDSD-PC and ATWT-M3 methods are relatively blurred and dark. Although the SFIM method retains edge information well in some areas, it has the problem of dark brightness. The CDIF method maintains edge information well but produces artifacts. Although the DMPIF and A-PNN methods retain spatial information well, their edges produce redundant color information and suffer from serious spectral distortion. The result of the method proposed in the disclosure is the closest to the GT image, and retains spatial and spectral information well. The objective evaluation fusion results are shown in Table 2, which is the objective evaluation fusion result of the downscaled image in the QuickBird dataset, with the ideal values marked in brackets and the optimal results marked in bold black. It may be seen that compared with the other 8 methods, the method proposed in the disclosure achieves the optimal results in all evaluation indexes, and the time taken by this method is short.

TABLE 2

| Fusion method | Q4 | PSNR | UIQI | RASE | ERGAS | SCC | Time (s) |
|---|---|---|---|---|---|---|---|
| GSA | 0.7204 | 28.0864 | 0.8680 | 45.9107 | 11.9279 | 0.8384 | 0.09 |
| NIHS | 0.7359 | 30.3936 | 0.8389 | 37.2876 | 9.2502 | 0.7884 | 0.02 |
| BDSD-PC | 0.7787 | 31.0244 | 0.8727 | 34.3589 | 8.8712 | 0.8241 | 0.11 |
| SFIM | 0.8228 | 31.9209 | 0.8953 | 31.4609 | 7.7403 | 0.8574 | 0.01 |
| ATWT-M3 | 0.7488 | 30.3354 | 0.8406 | 37.5634 | 9.2636 | 0.8173 | 0.12 |
| DMPIF | 0.6629 | 30.2939 | 0.8904 | 36.4980 | 9.3122 | 0.8485 | 4.14 |
| CDIF | 0.8426 | 32.0266 | 0.9133 | 31.0258 | 7.5931 | 0.7707 | 32.31 |
| A-PNN | 0.8315 | 31.5654 | 0.9071 | 32.5016 | 8.0506 | 0.7775 | 0.24 |
| Proposed | 0.8579 | 32.5524 | 0.9272 | 28.5341 | 7.0273 | 0.8595 | 0.66 |

### WorldView-2 Dataset:

in the subjective evaluation of fusion results of various comparison methods in the WorldView-2 dataset. After enlarging the local fusion results, it is able to be seen from the enlarged local area that the image definition of GSA, BDSD-PC and ATWT-M3 methods is poor, resulting in serious spatial distortion, and the color is dark. In the NIHS method, some areas have the problem of excessive injection of spatial information. Compared with the GT image, the SFIM method still has a certain gap in spatial information. The CDIF method has serious problems of image spatial distortion and spectral distortion. The image definition of the DMPIF method has a gap compared with the GT image, and the image has serious artifacts. In the A-PNN method, the spectrum of some areas is distorted, and the retention of spatial information is poor. The method proposed in the disclosure is the closest to the GT image, and its visual effect is better than other comparison methods. The objective evaluation fusion results are shown in Table 3, which is the objective evaluation fusion result of the downscaled image in the WorldView-2 dataset. Obviously, compared with the other 8 methods, the method proposed in the disclosure achieves the best results in all evaluation indexes, and the running time is also short.

### WorldView-3 Dataset:

in the subjective evaluation of fusion results of various methods in the WorldView-3 dataset. After enlarging the local fusion results, it is able to be seen from the enlarged local area that compared with the GT image, the roof of the house in the GSA method has a darker color. The image of the NIHS method produces certain artifacts, which affects the quality of image spatial information. The images of BDSD-PC, SFIM and ATWT-M3 methods are relatively blurred. Although the CDIF method retains spectral information well, its detail information retention is poor, resulting in serious spatial distortion. The color of DMPIF and A-PNN methods changes greatly, resulting in serious spectral distortion. The method proposed in the disclosure is the closest to the GT image, and achieves the best subjective visual effect. The objective evaluation fusion results are shown in Table 4, which is the objective evaluation fusion result of the downscaled image in the WorldView-3 dataset. It may be seen that the method of the disclosure achieves the best results in all evaluation indexes, and the running time is also short.

TABLE 3

| Fusion method | Q8 | PSNR | UIQI | RASE | ERGAS | SCC | Time (s) |
|---|---|---|---|---|---|---|---|
| GSA | 0.7415 | 23.0250 | 0.8260 | 28.4076 | 6.9257 | 0.8930 | 0.04 |
| NIHS | 0.8718 | 26.5331 | 0.9432 | 19.2262 | 4.7072 | 0.8983 | 0.01 |
| BDSD-PC | 0.8484 | 25.5758 | 0.9340 | 21.0005 | 5.3739 | 0.8675 | 0.10 |
| SFIM | 0.8924 | 26.9918 | 0.9521 | 18.0386 | 4.4243 | 0.9111 | 0.01 |
| ATWT-M3 | 0.8262 | 25.1100 | 0.9234 | 22.9734 | 5.5593 | 0.8554 | 0.25 |
| DMPIF | 0.8910 | 27.1957 | 0.9575 | 17.0660 | 4.2016 | 0.9054 | 4.47 |
| CDIF | 0.8407 | 24.9159 | 0.9321 | 22.7995 | 5.5670 | 0.6384 | 32.67 |
| A-PNN | 0.9149 | 27.7784 | 0.9617 | 16.2140 | 4.0000 | 0.9143 | 0.19 |
| Proposed | 0.9483 | 29.3102 | 0.9732 | 13.2903 | 3.3109 | 0.9412 | 0.67 |

### WorldView-3 Dataset:

in the subjective evaluation of the fusion results of various methods on the WorldView-3 dataset. After enlarging the local fusion results, it is able to be seen from the enlarged local area that, compared with the GT image, the color of the roof in the GSA method is darker. The image processed by the NIHS method has certain artifacts, which affects the quality of the spatial information of the image. The images processed by the BDSD-PC, SFIM and ATWT-M3 methods are relatively blurred. Although the CDIF method retains spectral information well, it retains detail information poorly and causes serious spatial distortion. The DMPIF and A-PNN methods result in significant color changes and serious spectral distortion. The method proposed in the present disclosure is the closest to the GT image and achieves the best subjective visual effect. The objective evaluation fusion results are shown in Table 4, which presents the objective evaluation fusion results of the downscaled images in the WorldView-3 dataset. It may be seen that the method of the present disclosure yields the best results in all evaluation indexes and has a relatively short running time.

TABLE 4

| Fusion method | Q8 | PSNR | UIQI | RASE | ERGAS | SCC | Time (s) |
|---|---|---|---|---|---|---|---|
| GSE | 0.8283 | 29.9868 | 0.8908 | 17.1739 | 4.0152 | 0.9135 | 0.04 |
| NIHS | 0.7839 | 29.8210 | 0.8978 | 17.8321 | 4.1553 | 0.8691 | 0.01 |
| BDSD-PC | 0.8185 | 30.3303 | 0.9203 | 16.1767 | 3.9888 | 0.8998 | 0.10 |
| SFIM | 0.8700 | 31.3094 | 0.9322 | 14.8694 | 3.4633 | 0.9081 | 0.02 |
| ATWT-M3 | 0.8025 | 29.6295 | 0.8928 | 18.7549 | 4.3115 | 0.8640 | 0.42 |
| DMPIF | 0.8684 | 31.8053 | 0.9511 | 13.2660 | 3.1358 | 0.9279 | 4.64 |
| CDIF | 0.8573 | 30.5537 | 0.9294 | 15.9662 | 3.7505 | 0.7900 | 36.70 |
| A-PNN | 0.8937 | 31.0437 | 0.9386 | 14.1669 | 3.4508 | 0.8945 | 0.30 |
| Proposed | 0.9206 | 32.8589 | 0.9579 | 11.5778 | 2.8134 | 0.9308 | 1.03 |

### RELATED CONCLUSIONS

since MS and PAN images are obtained by different sensors, this pair of source images usually have low correlation and similarity, and direct fusion may lead to serious spectral distortion and spatial distortion. Secondly, to obtain an ideal HRMS image, it is necessary to inject the spatial information of the PAN image into the UPMS image. However, inaccurate injected spatial information will lead to low spatial resolution of the HRMS image. To solve these main problems, the disclosure proposes a model based on multimodal texture correction and adaptive edge detail fusion. To obtain T_{C} hat is highly correlated and similar to MS and accurately inherits PAN spatial information, intensity constraints between T_{C} and I₀, gradient constraints between T_{C} and PAN, I₀, and deep plug-and-play constraints between T_{C} and Iₙₑₜ based on A-PNN are established, and an adaptive degradation filter algorithm is proposed to accurately maintain the constraints of the model. Finally, a multimodal texture correction model is constructed, which uses the ADMM algorithm to solve T_{C} to replace the function of the PAN image. Since spatial detail information exists not only in T_{C} but also in MS images, an adaptive edge detail fusion model is proposed, which extracts the detail information of T_{C} and UPMS images respectively and applies edge protection. To extract detail information more accurately, an algorithm for adaptively extracting T_{C} is used to extract details, and a Gaussian filter matched with MTF is used to extract UPMS images. The detail information of T_{C} with edge protection is adaptively fused with the enhanced detail information of UPMS images with edge protection. Finally, the injection model is used to inject the fused spatial information into the UPMS image to obtain the final HRMS image. In comparative experiments, the performance advantages of the algorithm of the disclosure are illustrated, and parameter analysis and ablation studies prove the effectiveness of the algorithm of the disclosure. The final results show that the algorithm proposed in the disclosure may obtain better fusion results.

In the multimodal texture correction model, since iterative optimization is performed in 2D images, the solution efficiency is greatly improved, and the 3 set correction prior terms may well retain spatial and spectral information. However, the model still has shortcomings. There are unknown parameters in the correction prior terms that need to be determined through experiments, which may consume a lot of computing resources and time. In the adaptive edge detail fusion model, to obtain accurate spatial information, the edge detail information of T_{C} and UPMS is comprehensively considered. However, problems such as the amount of injected spatial information and the ratio of UPMS spectral information to injected spatial information still exist. Therefore, our future work will focus on adaptively determining other unknown parameters in the pan-sharpening model and exploring more appropriate injection model methods to improve the overall performance and efficiency.

The above are only optional specific implementations of the present application, but the protection scope of the present application is not limited thereto. Any person skilled in the art may easily think of changes or substitutions within the technical scope disclosed in the present application, which should be covered within the protection scope of the present application. Therefore, the protection scope of the present application should be subject to the protection scope of the claims.

What is claimed is:

1. A pan-sharpening method based on multimodal texture correction and adaptive edge detail fusion, comprising following steps:
obtaining a low-resolution multispectral (LRMS) image and a panchromatic image, fusing an upsampled LRMS image with the panchromatic image to obtain a fused image, respectively extracting intensity components of the LRMS image and the fused image, inputting the intensity components and the panchromatic image into a multimodal texture correction model, and performing optimization solution on the multimodal texture correction model through an optimization method to obtain a texture-corrected image, wherein the multimodal texture correction model is constructed based on a variational optimization model; and
performing detail extraction and edge protection on the texture-corrected image to obtain first image details; performing detail extraction and edge protection on the upsampled LRMS image to obtain second image details; performing adaptive fusion on the first image details and the second image details to obtain detail information, and adding the detail information to the upsampled LRMS image to obtain a final high-resolution multispectral (HRMS) image;
wherein the multimodal texture correction model is:
$${T}_{C} = {arg min}_{{T}_{C}} \frac{1}{2} {‖ {DHT}_{C} - {I}_{0} ‖}_{F}^{2} + \frac{α}{2} {‖ {∇}^{2} {T}_{C} - {∇}^{2} P ‖}_{F}^{2} + \frac{β}{2} {‖ {∇}^{2} ( {DHT}_{C} ) - {∇}^{2} {I}_{0} ‖}_{F}^{2} + \frac{γ}{2} {‖ {T}_{C} - {I}_{net} ‖}_{F}^{2} + \frac{δ}{2} {‖ {∇}^{2} {T}_{C} - {∇}^{2} {I}_{net} ‖}_{F}^{2} + θ {‖ {∇}^{2} {T}_{C} ‖}_{1}$$
wherein T_{C} is the texture-corrected image, D represents a downsampling matrix, H represents a degradation filter, I₀ represents the intensity component of the LRMS image, α, β, γ, δ, θ represent penalty parameters corresponding to different terms, ∇² is a Laplacian operator, P represents the panchromatic image, Iₙₑₜ represents the intensity component of the fused image, | |F represents an Frobenius norm, and ∥·∥₁ represents a 1-norm;
wherein the degradation filter H is obtained through an adaptive degradation filter algorithm, wherein the degradation filter H adopts a Gaussian filter H_{A}, and the adaptive degradation filter algorithm is:
$${H}_{A} = {arg min}_{{H}_{A}} \frac{1}{2} {‖ {DH}_{A} {T}_{C} - {I}_{0} ‖}_{F}^{2}$$
wherein DH_{A}T_{C}=DF⁻¹(H_{A} (u, v) F(T_{C})); F(·) represents a fast Fourier transform (FFT) operation, and F⁻¹(·) represents an inverse fast Fourier transform (IFFT) operation; and
a frequency domain expression H_{A} (u, v) of the Gaussian filter H_{A} is:
$${H}_{A} ( u , v ) = {e}^{- \frac{{D}_{C}^{2} ( u , v )}{2 {σ}^{2}}}$$
wherein D_{C} (u, v) represents distance from a point (u, v) to a center of the frequency domain, σ represents standard deviation, and σ obtains an optimal value according to correlation and similarity indexes, and the optimal value of σ is σ_{best}:
$${σ}_{best} = {arg max}_{σ} \frac{ρ ( {DH}_{A} {T}_{C} , {I}_{0} ) + S ( {DH}_{A} {T}_{C} , {I}_{0} )}{2}$$
wherein ρ (DH_{A}T_{C}, I₀) is a correlation coefficient (CC) index between DH_{A}T_{C} and I₀, and S (DH_{A}T_{C}, I₀) is a structural similarity index measure (SSIM) index between the DH_{A}T_{C} and the I₀.

2. The method according to claim 1, wherein:
the intensity components of the LRMS image and the fused image are extracted by performing linear weighted summation on each band image of the LRMS image and each band image of the fused image.

3. The method according to claim 1, wherein the fused image is obtained by fusing the upsampled LRMS image with the panchromatic image through a pan-sharpening (A-PNN) model based on a target adaptive convolutional neural network.

4. The method according to claim 1, wherein the multimodal texture correction model is optimized and solved through an alternating direction method of multipliers (ADMM) model.

5. The method according to claim 1, wherein a process of extracting details from the texture-corrected image comprises:
$${D}_{{T}_{C}} = {T}_{C} - {T}_{CL}$$
wherein D_{TC} is image details of the texture-corrected image, T_{C} represents the texture-corrected image, T_{CL} is a low-resolution version of the texture-corrected image,
$${T}_{CL} = {χ}_{1} {I}_{UP} + ( 1 - {χ}_{1} ) {T}_{CD} s . t . 0 < {χ}_{1} < 1$$
wherein χ₁ represents a weight coefficient, I_{UP} represents an intensity component of the upsampled LRMS image, and T_{CD} represents an image of the texture-corrected image processed by the Gaussian filter;
$${χ}_{1} = \sqrt{1 - {e}^{- {x}_{3}}} s . t . {x}_{3} = \frac{{x}_{1}}{{x}_{1} + {x}_{2}}$$
wherein χ₃ represents a normalized weight, χ₁ represents an influence coefficient of I_{UP}, x₂ represents an influence coefficient of T_{CD}, a value of x₁ is a mean value of correlation and similarity between the T_{C} and the I_{UP}, and a value of χ₂ is a mean value of correlation and similarity between the T_{C} and the T_{CD}.

6. The method according to claim 1, wherein a process of adaptively fusing the first image details and the second image details comprises:
enhancing the second image details to a same level as first image details according to a scale factor ξ:
$${F}_{3}^{i} = {ξ}_{i} {F}_{2}^{i}$$
wherein F₂ represents the second image details, F₃ represents enhanced second image details, and superscript or subscript i represents a band label corresponding to an image; and
fusing the enhanced second image details with the first image details to obtain detail information F:
$${F}_{i} = {χ}_{2} {F}_{1} + ( 1 - {χ}_{2} ) {F}_{3}^{i}$$
wherein χ₂ is a weight coefficient, χ₂=\sqrt{1−e^{-x}^{₁}}, wherein x₁ represents an influence coefficient of I_{UP}, and a value of the x₁ is a mean value of correlation and similarity between the T_{C} and the I_{UP}, and F₁ represents the first image details.

7. The method according to claim 1, wherein a process of adding the detail information to the upsampled LRMS image comprises:
$${M}_{HR}^{i} = {M}_{UP}^{i} + {g}_{i} \frac{{M}_{UP}^{i}}{\frac{1}{B} {\sum }_{i = 1}^{B} {M}_{UP}^{i}} {F}_{i}$$
wherein g represents a scale factor of injected details, M_{UP} is the upsampled LRMS image, B represents total number of bands, i represents a band label, superscript or subscript i represents a band label corresponding to the image, F represents the detail information, and MER is the HRMS image.

8. The method according to claim 1, wherein a scale factor g for injected details is:
$${g}_{i} = \frac{{σ}^{2} ( {T}_{C} ) + cov ( {T}_{C} , {M}_{UP}^{i} )}{{σ}^{2} ( {T}_{C} )}$$
wherein cov(·) is a covariance function, σ² is a variance function, T_{C} represents the texture-corrected image, M_{UP} is the upsampled LRMS image, and superscript or subscript i represents a band label corresponding to the image.
